(19) United States
(12) Patent Application Publication
(10) Pub. No.: US 2023/0132158 A1
(43) Pub. Date: Apr. 27, 2023

(54) PROCESS FLOW MANAGMENT METHOD AND DEVICE

(71) Applicant: CHANGXIN MEMORY TECHNOLOGIES, INC., Hefei City (CN)

(72) Inventors: Daofeng ZHU, Hefei (CN); Ying XU, Hefei (CN)

(21) Appl. No.: 17/729,698

(22) Filed: Apr. 26, 2022

(30) Foreign Application Priority Data
Oct. 22, 2021 (CN) 202111231536.0

(51) Int. Cl. G05B 19/4099

(52) U.S. Cl. CPC G05B 19/4099; G05B 2219/45031

(57) ABSTRACT

A process flow management method and device are provided. The method includes: a main flow of a workpiece to be processed is provided, the main flow including multiple main process operations arranged in a preset order and operation nodes before and after each main process operation and between adjacent main process operations; a flow item change request for the workpiece is received, the flow item change request including a request for changing an operation time control interval, the operation time control interval starting from a first operation node and ending at a second operation node, and at least one main process operation being included between the first operation node and the second operation node; and in response to the flow item change request, a first reminder message is output to remind a user to set a safe operation time for the flow item change request.

### CROSS-REFERENCE TO RELATED APPLICATION

This application is based upon and claims priority to Chinese Patent Application No. 202111231536.0, filed on Oct. 22, 2021, the entire contents of which are incorporated herein by reference.

### BACKGROUND

The semiconductor production and processing process involves various chemical reactions. An operation duration is an important factor affecting the process effect and overall processing efficiency. Therefore, it is necessary to control the operation duration in part of production stages to improve resource utilization rate and production efficiency.

At present, when users change some production parameters, it may affect the originally set operation duration control function, resulting in the loss of control of the operation duration in processing, which not only affects the quality, yield and reliability of a product, but also wastes production resources and reduces the production efficiency.

### SUMMARY

Embodiments of this disclosure provide a process flow management method and device, which can solve the technical problem of failure of an operation duration control function of a process flow that may be caused when part of production parameters are changed.

Embodiments of the disclosure relate to the technical field of semiconductors, and particularly to a process flow management method and device.

In some embodiments, a method for process flow management is provided, which may include the following operations.

A main flow of a workpiece to be processed is provided, the main flow including multiple main process operations arranged in a preset order and operation nodes before and after each main process operation and between adjacent main process operations.

A flow item change request for the workpiece is received, the flow item change request including a request for changing an operation time control interval. The operation time control interval starts from a first operation node and ends at a second operation node, the first operation node and the second operation node are taken from the operation nodes of the main flow, and at least one of the main process operations is included between the first operation node and the second operation node.

A first reminder message is output in response to the flow item change request, the first reminder message being used to remind a user to set a safe operation time for the flow item change request.

In some embodiments, this disclosure provides an apparatus for process flow management, which may include a storage module, a receiving module, and a response module.

The storage module is configured to provide a main flow of a workpiece to be processed, the main flow including multiple main process operations arranged in a preset order and operation nodes before and after each main process operation and between adjacent main process operations.

The receiving module is configured to receive a flow item change request for the workpiece, the flow item change request including a request for changing an operation time control interval. The operation time control interval starts from a first operation node and ends at a second operation node, the first operation node and the second operation node are taken from the operation nodes of the main flow, and at least one of the main process operations is included between the first operation node and the second operation node.

The response module is configured to output a first reminder message in response to the flow item change request, the first reminder message being used to remind a user to set a safe operation time for the flow item change request.

In some embodiments, this disclosure provides a non-transitory computer-readable storage medium having stored therein a computer-executable instruction that when executed by a processor, may implement a method for process flow management, which may include the following operations.

A main flow of a workpiece to be processed is provided, the main flow including multiple main process operations arranged in a preset order and operation nodes before and after each main process operation and between adjacent main process operations.

A flow item change request for the workpiece is received, the flow item change request including a request for changing an operation time control interval. The operation time control interval starts from a first operation node and ends at a second operation node, the first operation node and the second operation node are taken from the operation nodes of the main flow, and at least one of the main process operations is included between the first operation node and the second operation node.

A first reminder message is output in response to the flow item change request, the first reminder message being used to remind a user to set a safe operation time for the flow item change request.

### BRIEF DESCRIPTION OF THE DRAWINGS

FIG. 1 is a flowchart of a method for process flow management according to an embodiment of this disclosure.

FIG. 2 is schematic diagram of a main flow according to an embodiment of this disclosure.

FIG. 3 is a schematic diagram of another main flow according to an embodiment of this disclosure.

FIG. 4 is schematic diagram of a flow item change according to an embodiment of this disclosure.

FIG. 5 is a schematic diagram of another flow item change according to an embodiment of this disclosure.

FIG. 6 is a simplified schematic diagram of a changed main flow according to an embodiment of this disclosure.

FIG. 7 is a simplified schematic diagram of another changed main flow according to an embodiment of this disclosure.

FIG. 8 is a schematic diagram of program modules of an apparatus for process flow management according to an embodiment of this disclosure.

FIG. 9 is a hardware structure diagram of an electronic device according to an embodiment of this disclosure.

### DETAILED DESCRIPTION

In order to make the objectives, technical solutions, and advantages of the embodiments of this disclosure clearer, the technical solutions in the embodiments of this disclosure will be clearly and completely described below in combination with the drawings in the embodiments of this disclosure. It is apparent that the described embodiments are not all embodiments but part of embodiments of this disclosure. Based on the embodiments in this disclosure, all other embodiments obtained by those skilled in the art without involving any inventive effort fall within the scope of protection of this disclosure. In addition, although the content in this disclosure is introduced according to one or several demonstrative examples, it is to be understood that each aspect of this disclosure can also individually constitute a complete implementation.

It is to be noted that, the brief description of the terms in this disclosure is only for the convenience of understanding the implementations described next, and is not intended to limit the implementations of this disclosure. Unless otherwise stated, these terms should be understood according to their ordinary and usual meanings.

The terms “first”, “second”, and the like in the specification and claims of this disclosure and in the above drawings are used to distinguish similar or like objects or entities and unnecessarily for limiting a specific sequence or sequential order, unless otherwise noted. It is to be understood that such terms may be interchangeable where appropriate, and can be, for example, implemented in a sequence in addition to those illustrated or described in the embodiments of this disclosure.

Furthermore, the terms “include” and “having”, as well as any variations thereof, are intended to cover a non-exclusive inclusion, for example, a product, or a device that includes a series of components is not necessarily limited to those expressly listed components, but may include other components not expressly listed or inherent to such product, or device.

The term “module” as used in this refers to any known or later developed hardware, software, firmware, artificial intelligence, fuzzy logic or combination of hardware or/and software code and can perform a disclosure function associated with the element.

In the field of integrated circuits or semiconductors, some production process stages require strict control of an operation time. In addition to setting the operation time in a single flow, it may also be necessary to set the operation time across flow nodes (between a main flow, an experimental flow, and a rework flows) to complete a function of controlling the operation time across the flow nodes, thereby preventing a user from omitting to set an operation time control interval when changing conventional production materials, resulting in the loss of control of a operation duration, and product rework or even scraping, which not only reduces the resource utilization rate and production efficiency, but also affects the quality, yield and reliability of the product.

The semiconductor production and processing process involves various chemical reactions. Operations and waiting durations are important factors affecting the process effect, product quality, and overall processing efficiency. Therefore, it is necessary to control the operation duration in part of production stages to improve the quality, yield, and reliability of a product, improve the resource utilization rate and production efficiency, and reduce the impact of environmental pollution.

The existing process flow control and management system only supports the setting of a time control start node in the same flow, and cannot directly set an operation time control interval across the flow. In addition, time control of a main flow and an experimental flow can only be implemented by the setting of replacing an original node of the main flow with a node of the experimental flow on the basis of the time control set in the main flow.

Since responsible persons for each production process are different, it is difficult for the same responsible person to accurately understand time control settings of other processes. When the responsible person changes part of production parameters, it may also affect the originally set operation duration control function, resulting in the loss of control of the operation duration of the process flow, which not only wastes production resources, but also reduces the production efficiency, and even affects the quality, yield and reliability of the product.

For the above technical problem, the embodiments of this disclosure provide a process flow management method, in which, after the user changes an operation time control interval, a reminder message is output to remind the user to set a new safe operation time, so as to prevent the operation duration of the process flow from getting out of control, which can not only avoid a waste of production resources but ensure the production efficiency. Detailed description is given below by using detailed embodiments.

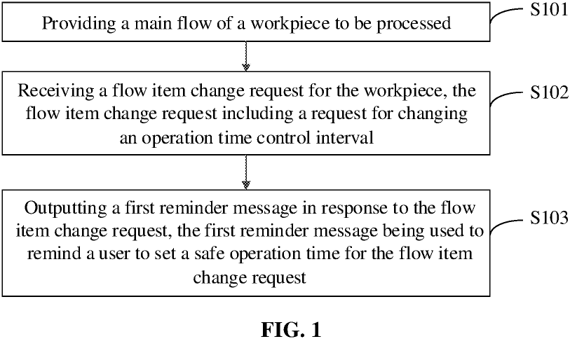

Referring to FIG. 1, FIG. 1 is a flowchart of a method for process flow management according to an embodiment of this disclosure. In a possible implementation, the method for process flow management includes the following operations.

At S101, a main flow of a workpiece to be processed is provided.

In the embodiment of this disclosure, the main flow includes multiple main process operations arranged in a preset order and operation nodes before and after each main process operation and between adjacent main process operations.

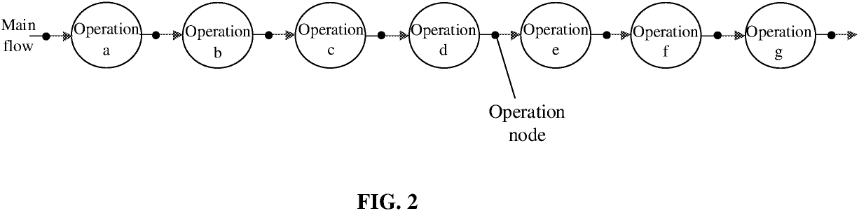

For better understanding of the embodiment of this disclosure, referring to FIG. 2, FIG. 2 is schematic diagram of a main flow according to an embodiment of this disclosure.

In some embodiments, the main flow includes multiple main process operations arranged in a preset order, such as including an operation a, an operation b, an operation c, ..., an operation f, an operation g, ....

Nodes before and after each main process operation and between adjacent main process operations are the operation nodes.

In some embodiments, the user can store the main flow of a workpiece to be processed in a management device in advance.

At S102, a flow item change request for the workpiece is received, the flow item change request including a request for changing an operation time control interval.

The operation time control interval starts from a first operation node and ends at a second operation node, the first operation node and the second operation node are taken from the operation nodes of the main flow, and at least one of the main process operations is included between the first operation node and the second operation node.

In some embodiments, the main flow is provided with some operation time control intervals, and each operation time control interval includes at least one process operation; during processing, a total processing duration of each process operation in each operation time control interval needs to be controlled within a preset operation duration of each operation time control interval.

In some embodiments, some experimental flows may be set in the main flow to replace sub-flows in the main flow.

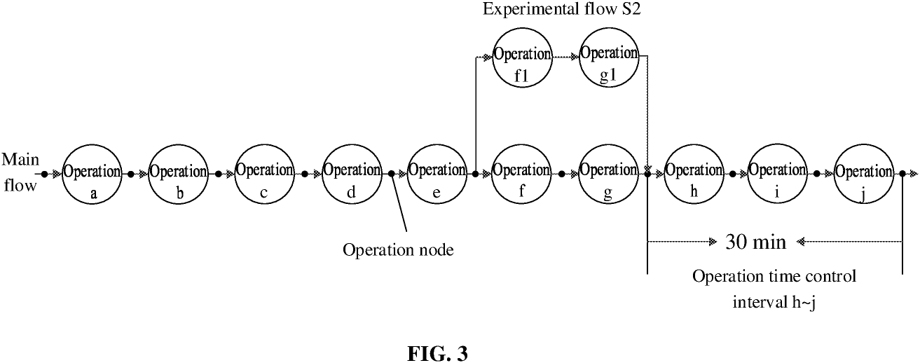

For better understanding of the embodiment of this disclosure, referring to FIG. 3, FIG. 3 is a schematic diagram of another main flow according to an embodiment of this disclosure.

As illustrated in FIG. 3, the main flow has multiple main process operations arranged in a preset order, including an operation a, an operation b, an operation c, ..., an operation i, an operation j, ....

“Operation time control intervals h-j” are set in the main flow, for controlling a total operation duration of the operation h, the operation i, and the operation j within 30 minutes.

In addition, an experimental flow S2 is also provided in the main flow, the experimental flow S2 including an operation f1 and an operation g1, for replacing the operation f and operation g in the main flow.

The operation f to the operation g in the main flow are one sub-flow in the main flow.

In a possible implementation, when needing to change a flow item of the workpiece, the user may submit a flow item change request to the management device.

Exemplarily, the process item change request may include adding an operation time control interval in the main flow, deleting an operation time control interval in the main flow, and modifying a start operation node and/or end operation node of an existing operation time control interval in the main flow, as well as adding a new experimental flow in the main flow, deleting an experimental flow in the main flow, modifying a start operation node and/or end operation node of an existing experimental flow in the main flow, and the like, which are not limited in the embodiment of this disclosure.

At S103, a first reminder message is output in response to the flow item change request, the first reminder message being used to remind the user to set a safe operation time for the flow item change request.

In some embodiments, after receiving the flow item change request, the management device outputs the first reminder message according to the changed content corresponding to the flow item change request, the first reminder message being used to remind the user to set a safe operation time for the flow item change request.

In a possible implementation, after receiving the flow item change request, the management device determines, according to preset rules, whether the flow item change request will affect the operation time control function set in the main flow, if yes, the management device outputs the first reminder message to remind the user to set a safe operation time for the flow item change request.

In some embodiments, after the user submits the flow item change request, on the one hand, the management device reads from the production system database a start operation node of the set operation time control interval, an experimental flow ID, a start operation node and an end operation node of the experimental flow, and information about the experimental flow replacing a sub-flow in the main flow. On the other hand, the management device reads a start operation node and an end operation node of an added/modified/deleted operation time control interval in the flow item change request.

The management device summarizes the read data; determines, according to preset rules, whether the start operation node and the end operation node of the experimental flow are within the operation time control interval in the flow item change request; if yes, the management device continues to determine whether information about the corresponding experimental flow replacing the sub-flow in the original main flow exists in the production system database or the flow item change request, if the information exists, the management device continues a submitting action, otherwise, he management device outputs a reminder message or an error report so as to remind the user to set a safe operation time for the flow item change request.

In a possible implementation, if it is determined that the start operation node and the end operation node of the experimental flow are both within a certain time control interval of the main flow (that is, the control function may be affected), a reminder message can be output by means of a pop-up window, reminding the user to determine whether the sub-flow in the main flow needs to be replaced with the experimental flow.

If it is determined that only one of the start operation node and the end operation node of the experimental flow is within a certain time control interval of the main flow (that is, the control function is affected absolutely), it is determined whether the user has set a safe operation time for the process item change request; if not, a reminder message is output to remind the user to set a safe operation time for the flow item change request.

In some embodiments, the reminder message or the error report information may include an error information link, the user clicks the link to download an information file, and then position information of the safe operation time required to be set in the main flow may be determined through the information file.

According to the process flow management method provided in the embodiment of this disclosure, when the user requests to change the operation time control interval, the reminder message is output to remind the user to set a new safe operation time, so as to prevent the operation duration of the process flow from getting out of control, which can not only avoid a waste of production resources but ensure the production efficiency and quality, yield, and reliability of the product.

On the basis of the content described in the above embodiment, in some embodiments, the request for changing an operation time control interval refers to: when adding or modifying an experimental flow to replace a sub-flow in the main flow, first determining a first experimental flow that is added or modified; if a start operation node and an end operation node of the first test process are not within the same operation time control interval, determining whether a safe operation time is set for the first experimental flow; if not, outputting a first reminder message to remind the user to set a safe operation time for the first experimental flow.

It can be understood that if the start operation node and end operation node of the first experimental flow are not within the same operation time control interval, it means that the first experimental flow crosses a start node of the operation time control interval; in this case, a timing function cannot be triggered at the start operation node of the first experimental flow, resulting the loss of control of a operation duration of the first experimental flow.

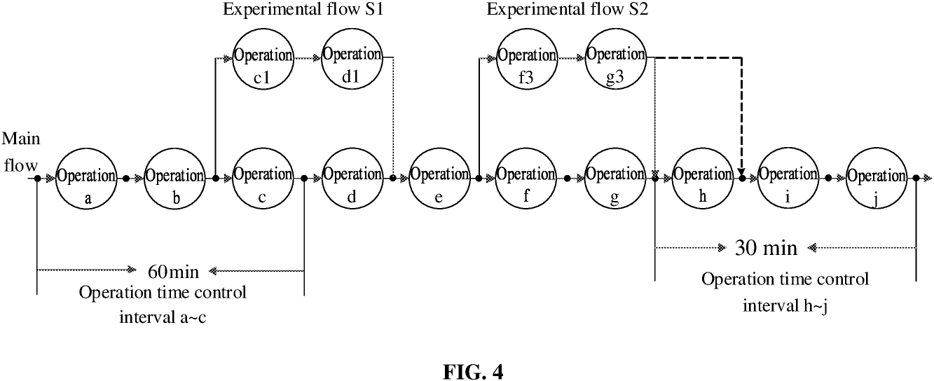

For better understanding of the embodiment of this disclosure, referring to FIG. 4, FIG. 4 is schematic diagram of a flow item change according to an embodiment of this disclosure.

As illustrated in FIG. 4, the main process has multiple main process operations arranged in a preset order, including an operation a, an operation b, an operation c, ..., an operation i, an operation j, .... “Operation time control intervals a-c” and “Operation time control intervals h-j” are set in the main flow. “Operation time control interval a-c” are set for controlling a total operation duration of the operation a, the operation b, and the operation c within 60 minutes, and “operation time control intervals h-j” are set for controlling a total operation duration of the operation h, the operation i, and the operation j within 30 minutes.

It is assumed that the request for changing an operation time control interval refers to adding an experimental flow S1. The experimental flow S1 includes an operation c1 and an operation d1. The experimental flow S1 may be used to replace a sub-flow composed of the operation c and the operation d in the main flow.

As illustrated in FIG. 4, the added experimental flow S1 crosses the “operation time control interval a-c”, which will cause a start node of the experimental flow S1 to fail to trigger the timing function, so that it cannot control a operation duration of the experimental flow S1.

In some embodiments, when it is determined that the experimental flow S1 crosses the “operation time control intervals a-c”, it is determined whether a safe operation time is set for the experimental flow S1; if no safe operation time is set, a reminder message is output to remind the user to set a safe operation time for the experimental flow S1 to control the operation duration of the experimental flow S1.

In some embodiments, it is assumed that the request for changing an operation time control interval refers to modifying an operation node of an experimental flow S2 that returns to the main flow. Specifically, the operation node of the experimental flow S2 that returns to the main flow is modified from an operation node between the operation g and the operation h into an operation node between the operation h and the operation i.

As illustrated in FIG. 4, it can be seen that the modified experimental process S2 crosses the operation time control interval h-j. Then, if an operation duration of the modified experimental process S2 needs to be managed and controlled, the user needs to be reminded to set a safe operation time for the modified experimental flow S2.

In some embodiments, if the request for changing an operation time control interval refers to deleting an experimental flow in the main process, after the experimental flow is deleted, it can be determined whether a safe operation time is set for the deleted experimental flow; if yes, a reminder message is output to remind the user to delete the safe operation time corresponding to the deleted experimental flow.

In the process flow management method provided by the embodiment of this disclosure, after the added or modified experimental flow replaces the sub-flow in the main flow, if a start operation node and end operation node of the added or modified experimental flow are not within the same operation time control interval, it is determined whether a safe operation time is set for the experimental flow; if not, the user is reminded to set a safe operation time for the experimental flow, so as to prevent the operation duration of the process flow from getting out of control.

On the basis of the content described in the above embodiment, in some embodiments, the request for changing an operation time control interval may also refer to adding or modifying an operation time control interval in the main flow.

In some embodiments, when the request for changing an operation time control interval refers to adding or modifying an operation time control interval in the main flow, an added or modified first operation time control interval is determined; moreover, it is determined whether a first experimental flow exists to replace a first sub-flow in the main flow; if the first experimental flow exists, a reminder message is output to remind the user to set a safe operation time for the first experimental flow.

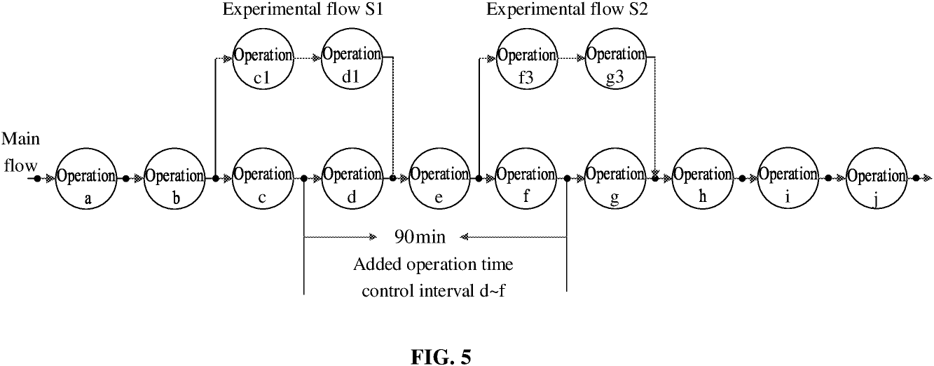

For better understanding of the embodiment of this disclosure, referring to FIG. 5, FIG. 5 is a schematic diagram of another flow item change according to an embodiment of this disclosure.

As illustrated in FIG. 5, the main process has multiple main process operations arranged in a preset order, including an operation a, an operation b, an operation c, ..., an operation i, an operation j, .... “Operation time control interval a-c” and “operation time control interval h-j” are set in the main flow. “Operation time control interval a-c” is set for controlling a total operation duration of the operation a, the operation b, and the operation c within 60 minutes, and “operation time control interval h-j” is set for controlling a total working time of the operation h, the operation i, and the operation j within 30 minutes.

In addition, the main flow also includes an experimental flow S1 and an experimental flow S2.

Assume that the request for changing an operation time control interval refers to adding “operation time control interval d-f” in the main flow to control a total operation duration of the operation d, the operation e, and the operation f within 90 minutes. It can be seen from FIG. 5 that the experimental flow S1 and the experimental flow S2 both have intersections with the “operation time control interval d-f”. In order to control operation durations of the experimental flow S1 and the experimental flow S2, it needs to remind the user to set a safe operation time for the experimental flow S1 and a safe operation time for the experimental flow S2.

In some embodiments, when the request for changing an operation time control interval refers to deleting an operation time control interval in the main flow; after the corresponding operation time control interval is deleted, it can be determined whether there exists a target sub-flow with a start operation node and an end operation node that are respectively identical to a start operation node and an end operation node of the deleted operation time control interval; in response that there exists the target sub-flow, then a reminder message is output to remind the user to delete the target sub-flow.

In the process flow management method provided by the embodiment of this disclosure, after the operation time control interval in the main flow is changed, if an experimental flow in the main flow that intersects with the changed operation time control interval exists, it is determined whether a safe operation time is set for the experimental flow; if not, the user is reminded to set a safe operation time for the experimental flow, so as to prevent the operation duration of the process flow from getting out of control.

On the basis of the content described in the above embodiment, in some embodiments, it is assumed that the start operation node of the experimental flow is called a connect operation node, and the end operation node of the experimental flow is called a join operation node. In addition, the start operation node of the operation time control interval in the main flow is called a trigger time node, and the end operation node of the operation time control interval is called a target time node.

Then, in a possible implementation, an experimental flow can be added to the main flow by specifying a connect operation node and a join operation node in the main flow; the existing experimental flow in the main flow is modified by replacing the specified connect operation node and/or join operation node in the main flow; and the existing experimental flow in the main flow is deleted by deleting the specified connect operation node and join operation node in the main flow.

Similarly, an operation time control interval can be added to the main flow by specifying a trigger time node and a target time node in the main flow; the existing operation time control interval in the main flow is modified by replacing the specified trigger time node and target time node in the main flow; and the existing operation time control interval in the main flow is deleted by deleting the specified trigger time node and target time node in the main flow.

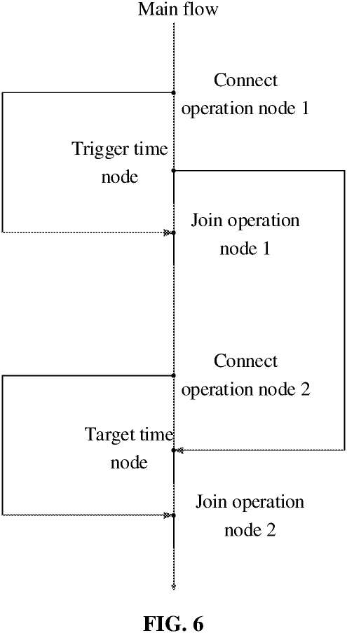

For better understanding of the embodiment of this disclosure, referring to FIG. 6, FIG. 6 is a simplified schematic diagram of a changed main flow according to an embodiment of this disclosure.

In some embodiments, it is assumed that in the changed main flow, a join operation node 1 is between the trigger time node and the target time node, a connect operation node 1 is not between the trigger time node and the target time node; and, a join operation node 2 is not between the trigger time node and the target time node, the connect operation node 2 is between the trigger time node and the target time node.

In a possible implementation, if the trigger time node and the target time node are originally specified nodes in the main flow, and when the connect operation node 1, the join operation node 1, the connect operation node 2, and the join operation node 2 are added or modified operation nodes, it is necessary to determine whether a safe operation time is set for an experimental flow between the connect operation node 1 and the join operation node 1 as well as an experimental flow between the connect operation node 2 and the join operation node 2; if it is not set, a reminder message is output to remind the user to set the safe operation time.

When the connect operation node 1, the join operation node 1, the connect operation node 2, and the join operation node 2 are operation nodes that need to be deleted, it can be determined whether the user has an operation of deleting the trigger time node and the target time node. If the operation does not exist, a reminder message is output to remind the user to delete the corresponding safe operation time, such as reminding the user to delete the trigger time node and the target time node.

In another possible implementation, if the connect operation node 1, the join operation node 1, the connect operation node 2, and the join operation node 2 are originally set operation nodes in the main flow, and when the trigger time node and the target time node are the added or modified operation nodes, it needs to determine whether a safe operation time is set for an experimental flow between the connect operation node 1 and the join operation node 1 as well as for an experimental flow between the connect operation node 2 and the join operation node 2; if it is not set, a reminder message is output to remind the user to set the safety operation time. Then, the user can add the safe operation time by adding a new trigger time node and target time node in the main flow.

When the trigger time node and the target time node are operation nodes that need to be deleted, it can be determined whether the user has an operation of deleting the join operation node and the connect operation node; if the operation does not exists, a reminder message is output to remind the user to delete the corresponding experimental flow, such as reminding the user to delete the connect operation node 1, the join operation node 1, the connect operation node 2, and the join operation node 2.

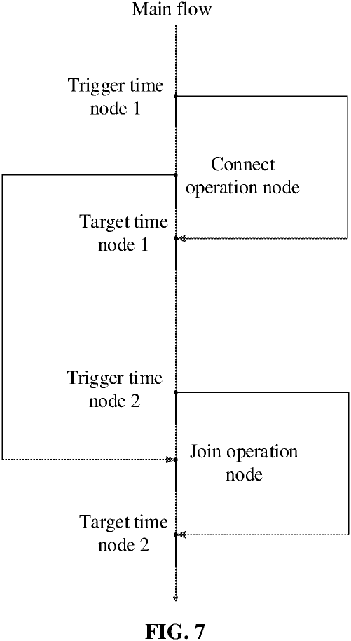

For better understanding of the embodiment of this disclosure, in some other embodiments, referring to FIG. 7, FIG. 7 is a simplified schematic diagram of another changed main flow according to an embodiment of this disclosure.

In some embodiments, it is assumed that in the changed main flow, a connect operation node is between a trigger time node 1 and a target time node 1, and a join operation node is between a trigger time node 2 and a target time node 2.

In a possible implementation, if the trigger time node 1, the target time node 1, the trigger time node 2, and the target time node 2 are originally set nodes in the main flow, and when the connect operation node and the join operation node are the added or modified operation nodes, it needs to determine whether a safe operation time is set for an experimental flow between the connect operation node and the join operation node; if it is not set, a reminder message is output to remind the user to set the safe operation time.

When the connect operation node and the join operation node are operation nodes that need to be deleted, it can be determined whether the user has an operation of deleting the trigger time nodes. If the operation does not exist, a reminder message is output to remind the user to delete the corresponding safe operation time, such as reminding the user to delete the trigger time node 1, the target time node 1, the trigger time node 2, and the target time node 2.

In another possible implementation, if the connect operation node and the join operation node are originally set operation nodes in the main flow, and when the trigger time node 1, the target time node 1, the trigger time node 2, and the target time node 2 are the added or modified operation nodes, it needs to determine whether a safe operation time is set for an experimental flow between the connect operation node and the join operation node; if it is not set, a reminder message is output to remind the user to set the safe operation time. Then, the user can add the safe operation time by adding a new trigger time node and target time node in the main flow.

When the trigger time node 1, the target time node 1, the trigger time node 2, and the target time node 2 are operation nodes that need to be deleted, it can be determined whether the user has an operation of deleting the join operation node and the connect operation node; if the operation does not exist, a reminder message is output to remind the user to delete the corresponding experimental flow, such as reminding the user to delete the connect operation node and the join operation node.

In the process flow management method provided in the embodiment of this disclosure, when the connect operation node and the join operation node in the main flow are split/skipped by two related trigger time nodes, or when two related trigger time nodes are split/skipped by the connect operation node and the join operation node, the reminder message is output to remind the user to set a new safe operation time so as to prevent the operation duration of the process flow from getting out of control, which can not only avoid a waste of production resources but ensure the production efficiency and quality, yield, and reliability of the product.

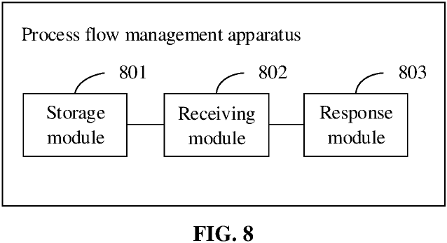

On the basis of the content described in the above embodiment, an embodiment of this disclosure further provides an apparatus for process flow management. Referring to FIG. 8, FIG. 8 is a schematic diagram of program modules of an apparatus for process flow management according to an embodiment of this disclosure. The process flow management apparatus includes a storage module 801, a receiving module 802, and a response module 803.

The storage module 801 is configured to provide a main flow of a workpiece to be processed, the main flow including multiple main process operations arranged in a preset order and operation nodes before and after each main process operation and between adjacent main process operations.

The receiving module 802 is configured to receive a flow item change request for the workpiece, the flow item change request including a request for changing an operation time control interval. The operation time control interval starts from a first operation node and ends at a second operation node; the first operation node and the second operation node are taken from the operation nodes of the main flow, and at least one of the main process operations is included between the first operation node and the second operation node.

The response module 803 is configured to output a first reminder message in response to the flow item change request, the first reminder message being used to remind a user to set a safe operation time for the flow item change request.

According to the process flow management apparatus provided in the embodiment of this disclosure, after the operation time control interval is changed, the reminder message is output to remind the user to set a new safe operation time, so as to prevent the operation duration of the process flow from getting out of control, which can not only avoid a waste of production resources but ensure the production efficiency.

In a possible implementation, the request for changing an operation time control interval may include the following operation.

An experimental flow is added or modified to replace a sub-flow of the main flow. The experimental flow and the sub-flow both start from a third operation node and end at a fourth operation node, the third operation node and the fourth operation node are taken from the operation nodes in the main flow, and the experimental flow or the sub-flow has an intersection with the operation time control interval.

In a possible implementation, the response module 803 is configured to perform the following operations.

A first experimental flow that is added or modified is determined in response to the flow item change request; when a start operation node and an end operation node of the first experimental flow are not within the same operation time control interval, it is determined whether a safe operation time is set for the first experimental flow; if no safe operation time is set for the first experimental flow, a first reminder message is output to remind the user to set a safe operation time for the first experimental flow.

In a possible implementation, the request for changing an operation time control interval further includes: deleting the experimental flow.

The response module 803 is further configured to perform the following operations.

After the experimental flow is deleted, it is determined whether a safe operation time is set for the deleted experimental flow; if a safe operation time is set for the deleted experimental flow, a third reminder message is output to remind the user to delete the safe operation time corresponding to the deleted experimental flow.

In a possible implementation, the request for changing an operation time control interval includes the following operation.

The operation time control interval is added or modified.

In a possible implementation, the response module 803 is specifically configured to perform the following operations.

A first operation time control interval that is added or modified is determined in response to the flow item change request; it is determined whether a first experimental flow exists to replace a first sub-flow in the main flow. The first experimental flow and the first sub-flow both start from a third operation node and end at a fourth operation node, the third operation node and the fourth operation node are taken from the operation nodes in the main flow, and the experimental flow or the sub-flow has an intersection with the first operation time control interval. If the first experimental flow exists, a first reminder message is output to remind the user to set a safe operation time for the first experimental flow.

In a possible implementation, the request for changing an operation time control interval includes: deleting the operation time control interval.

The response module 803 is further configured to perform the following operations.

After deleting the operation time control interval, it is determined whether there exists a target sub-flow with a start operation node and an end operation node that are respectively identical to a start operation node and an end operation node of the deleted operation time control interval; in response that there exists the target sub-flow, a second reminder message is output, and the second reminder message is used to remind the user to delete the target sub-flow.

It is to be noted that the specific execution content of the storage module 801, the receiving module 802, and the response module 803 in the embodiment of this disclosure is consistent with the content executed by each operation in the process flow management method described in the foregoing embodiment. For details, reference may be made to each operation in the process flow management method described in the foregoing embodiment, which will not be repeated in the embodiment of this disclosure.

Further, on the basis of the content described in the above embodiments, an embodiment of this disclosure further provides user equipment. The user equipment includes at least one processor and a memory; the memory stores a computer-executable instruction; and the at least processor executes the computer-executable instruction stored in the memory to implement various steps in the process flow management method described in the foregoing embodiment.

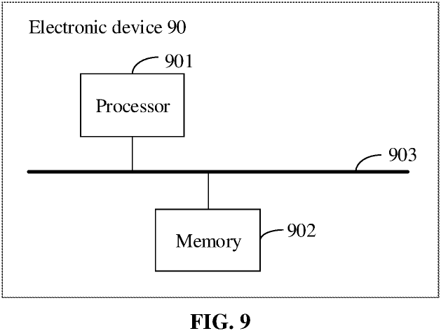

For better understanding of the embodiment of this disclosure, referring to FIG. 9, FIG. 9 is a hardware structure diagram of an electronic device according to an embodiment of this disclosure.

As illustrated in FIG. 9, an electronic device 90 according to the embodiment includes: a processor 901 and a memory 902.

The memory 902 is configured to store a computer-executable instruction.

The processor 901 is configured to execute the computer-executable instruction stored in the memory to implement various steps in the process flow management method described in the foregoing embodiments. For details, reference may be made to the content described in the foregoing embodiments, which will not be repeated in the embodiment of this disclosure.

Optionally, the memory 902 may be independent, or may be integrated with the processor 901.

When the memory 902 is arranged independently, the device further includes a bus 903 configured to connect the memory 902 with the processor 901.

Further, on the basis of the content described in the above embodiments, an embodiment of this disclosure further provides a computer-readable storage medium having stored therein a computer-executable instruction which, when executed by a processor, may implement various steps of the process flow management method as described in the foregoing embodiments. For details, reference may be made to the content described in the foregoing embodiments, which will not be repeated in the embodiment of this disclosure.

Further, on the basis of the content described in the above embodiments, an embodiment of this disclosure further provides a computer program product, which includes a computer program. When the computer program is executed by a processor, various steps of the process flow management method as described in the foregoing embodiments may be implemented. For details, reference may be made to the content described in the foregoing embodiments, which will not be repeated in the embodiment of this disclosure.

In some embodiments provided by this disclosure, it is to be understood that the disclosed device and method may be implemented in another manner. For example, the device embodiment described above is only schematic, and for example, division of the modules is only logic function division, and other division manners may be adopted during practical implementation. For example, multiple modules may be combined or integrated into another system, or some characteristics may be neglected or not executed. In addition, coupling or direct coupling or communication connection between each displayed or discussed component may be indirect coupling or communication connection, implemented through some interfaces, of the apparatus or the modules, and may be electrical and mechanical or adopt other forms.

The modules described as separate parts may or may not be physically separated, and parts displayed as modules may or may not be physical units, and namely may be located in the same place, or may also be distributed to multiple network units. Part or all of the modules may be selected to achieve the purposes of the solutions of the embodiments as practically required.

In addition, each function module in each embodiment of this disclosure may be integrated into a processing module, or each module may also physically exist independently, or two or more than two modules may also be integrated into a unit. The module integrated unit may be implemented in a hardware form, or may be implemented in form of hardware and software function unit.

The integrated module implemented in form of a software function module may be stored in a computer-readable storage medium. The software function module is stored in a storage medium, including a plurality of instructions configured to enable a computer device (which may be a personal computer, a server, a network device, etc.) or a processor to execute part of the steps of the method in each embodiment of this disclosure.

It should be understood that the processor may be a Central Processing Unit (CPU), or another general-purpose processor, a Digital Signal Processor (DSP), an Application Specific Integrated Circuit (ASIC), and the like. The general purpose processor may be a microprocessor or the processor may also be any conventional processor, and the like. The steps of the method disclosed in combination with this disclosure may be directly embodied to be executed and completed by a hardware processor or executed and completed by a combination of hardware and software modules in the processor.

The memory may include a high-speed Random Access Memory (RAM), or may include a Non-Volatile Memory (NVM), for example, at least one disk memory, or may be a U disk, a mobile hard disk, a Read-Only Memory (ROM), a magnetic disk, an optical disk, etc.

The bus may be an Industry Standard Architecture (ISA) bus, a Peripheral Component (PCI) bus or an Extended Industry Standard Architecture (EISA) bus, and the like. The bus may be divided into an address bus, a data bus, a control bus, and the like. For ease of representation, the bus in the drawings of this disclosure is not limited to only one bus or one type of bus.

The storage medium may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk. The storage medium may be any available medium accessible for a general-purpose or special-purpose computer.

An example storage medium is coupled to a processor, such that the processor can read information from, and write information to, the storage medium. The storage medium can also be a component of the processor. The processor and the storage medium may be located in the Application Specific Integrated Circuits (ASIC for short). The processor and the storage medium may also exist in the electronic device or master control device as discrete components.

It can be understood by those of ordinary skill in the art that all or part of the steps of each method embodiment may be completed by instructing related hardware through a program. The program may be stored in a computer-readable storage medium. When the program is executed, operations including the steps of each method embodiment described above are executed. The foregoing storage medium includes: various media capable of storing program codes, such as a U disk, a mobile hard disk, a ROM, a RAM, a magnetic disk, or an optical disk.

It is to be noted at last: the above various embodiments are only used to illustrate the technical solutions of this disclosure and not used to limit the same. Although this disclosure has been described in detail with reference to the foregoing embodiments, for those of ordinary skill in the art, they can still modify the technical solutions described in the foregoing embodiments, or equivalently replace part or all of the technical features; all these modifications and replacements shall not cause the essence of the corresponding technical solutions to depart from the scope of the technical solutions of the embodiments of this disclosure.

1. A method for a process flow management, comprising:
providing a main flow of a workpiece to be processed, the main flow comprising a plurality of main process operations arranged in a preset order and operation nodes before and after each main process operation and between adjacent main process operations;
receiving a flow item change request for the workpiece, the flow item change request comprising a request for changing an operation time control interval, wherein the operation time control interval starts from a first operation node and ends at a second operation node, the first operation node and the second operation node are taken from the operation nodes of the main flow, and at least one of the main process operations is comprised between the first operation node and the second operation node; and
outputting a first reminder message in response to the flow item change request, the first reminder message being used to remind a user to set a safe operation time for the flow item change request.

2. The method of claim 1, wherein the request for changing the operation time control interval comprises:
adding or modifying an experimental flow to replace a sub-flow in the main flow, wherein the experimental flow and the sub-flow both start from a third operation node and end at a fourth operation node, the third operation node and the fourth operation node are taken from the operation nodes of the main flow, and the experimental flow or the sub-flow has an intersection with the operation time control interval.

3. The method of claim 2, wherein that outputting the first reminder message in response to the flow item change request comprises:
in response to the flow item change request, determining a first experimental flow that is added or modified;
when a start operation node and an end operation node of the first experimental flow are not within the same operation time control interval, determining whether a safe operation time is set for the first experimental flow; and
in response that no safe operation time is set for the first experimental flow, outputting the first reminder message, the first reminder message being used to remind the user to set a safe operation time for the first experimental flow.

4. The method of claim 3, wherein the request for changing the operation time control interval further comprises:
deleting the experimental flow;
the method further comprises:
after deleting the experimental flow, determining whether a safe operation time is set for the deleted experimental flow; and
in response that the safe operation time is set for the deleted experimental flow, outputting a third reminder message, the third reminder message being used to remind the user to delete the safe operation time corresponding to the deleted experimental flow.

5. The method of claim 1, wherein the request for changing the operation time control interval comprises: adding or modifying the operation time control interval.

6. The method of claim 5, wherein that outputting the first reminder message in response to the flow item change request comprises:
in response to the flow item change request, determining a first operation time control interval that is added or modified;
determining whether a first experimental flow exists to replace a first sub-flow in the main flow, wherein the first experimental flow and the first sub-flow both start from a third operation node and end at a fourth operation node, the third operation node and the fourth operation node are taken from the operation nodes of the main flow, and the first experimental flow or the first sub-flow has an intersection with the first operation time control interval; and
outputting the first reminder message in response that the first experimental flow exists, the first reminder message being used to remind the user to set a safe operation time for the first experimental flow.

7. The method of claim 6, wherein the request for changing the operation time control interval comprises:
deleting the operation time control interval;
the method further comprises:
after deleting the operation time control interval, determining whether there exists a target sub-flow with a start operation node and an end operation node that are respectively identical to a start operation node and an end operation node of the deleted operation time control interval; and
outputting a second reminder message in response that there exists the target sub-flow, the second reminder message being used to remind the user to delete the target sub-flow.

8. An apparatus for a process flow management, comprising:
a processor; and
a memory configured to store an instruction executable for the processor,
wherein the processor is configured to:
provide a main flow of a workpiece to be processed, the main flow comprising a plurality of main process operations arranged in a preset order and operation nodes before and after each main process operation and between adjacent main process operations;
receive a flow item change request for the workpiece, the flow item change request comprising a request for changing an operation time control interval, wherein the operation time control interval starts from a first operation node and ends at a second operation node, the first operation node and the second operation node are taken from the operation nodes of the main flow, and at least one of the main process operations is comprised between the first operation node and the second operation node; and
output a first reminder message in response to the flow item change request, the first reminder message being used to remind a user to set a safe operation time for the flow item change request.

9. The apparatus of claim 8, wherein the request for changing the operation time control interval comprises:
adding or modifying an experimental flow to replace a sub-flow in the main flow, wherein the experimental flow and the sub-flow both start from a third operation node and end at a fourth operation node, the third operation node and the fourth operation node are taken from the operation nodes in the main flow, and the experimental flow or the sub-flow has an intersection with the operation time control interval.

10. The apparatus of claim 9, wherein the processor is further configured to:
in response to the flow item change request, determine a first experimental flow that is added or modified;
when a start operation node and an end operation node of the first experimental flow are not within the same operation time control interval, determine whether a safe operation time is set for the first experimental flow; and
in response that no safe operation time is set for the first experimental flow, output the first reminder message, the first reminder message being used to remind the user to set a safe operation time for the first experimental flow.

11. The apparatus of claim 10, wherein the request for changing the operation time control interval further comprises:
deleting the experimental flow;
the processor is further configured to:
after deleting the experimental flow, determine whether a safe operation time is set for the deleted experimental flow; and
in response that the safe operation time is set for the deleted experimental flow, output a third reminder message, the third reminder message being used to remind the user to delete the safe operation time corresponding to the deleted experimental flow.

12. The apparatus of claim 8, wherein the request for changing the operation time control interval comprises: adding or modifying the operation time control interval.

13. The apparatus of claim 12, wherein the processor is specifically configured to:
in response to the flow item change request, determine a first operation time control interval that is added or modified;
determine whether a first experimental flow exists to replace a first sub-flow in the main flow, wherein the first experimental flow and the first sub-flow both start from a third operation node and end at a fourth operation node, the third operation node and the fourth operation node are taken from the operation nodes of the main flow, and the first experimental flow or the first sub-flow has an intersection with the first operation time control interval; and
output the first reminder message in response that the first experimental flow exists, the first reminder message being used to remind the user to set a safe operation time for the first experimental flow.

14. The apparatus of claim 13, wherein the request for changing the operation time control interval comprises:
deleting the operation time control interval;
the processor is further configured to:
after deleting the operation time control interval, determine whether there exists a target sub-flow with a start operation node and an end operation node that are respectively identical to a start operation node and an end operation node of the deleted operation time control interval; and
output a second reminder message in response that there exists the target sub-flow, the second reminder message being used to remind the user to delete the target sub-flow.

15. A non-transitory computer-readable storage medium having stored therein a computer-executable instruction that when executed by a processor, implements a method for process flow management, wherein the method comprises:
providing a main flow of a workpiece to be processed, the main flow comprising a plurality of main process operations arranged in a preset order and operation nodes before and after each main process operation and between adjacent main process operations;
receiving a flow item change request for the workpiece, the flow item change request comprising a request for changing an operation time control interval, wherein the operation time control interval starts from a first operation node and ends at a second operation node, the first operation node and the second operation node are taken from the operation nodes of the main flow, and at least one of the main process operations is comprised between the first operation node and the second operation node; and
outputting a first reminder message in response to the flow item change request, the first reminder message being used to remind a user to set a safe operation time for the flow item change request.

16. The non-transitory computer-readable storage medium of claim 15, wherein the request for changing the operation time control interval comprises:
adding or modifying an experimental flow to replace a sub-flow in the main flow, wherein the experimental flow and the sub-flow both start from a third operation node and end at a fourth operation node, the third operation node and the fourth operation node are taken from the operation nodes of the main flow, and the experimental flow or the sub-flow has an intersection with the operation time control interval.

17. The non-transitory computer-readable storage medium of claim 16, wherein that outputting the first reminder message in response to the flow item change request comprises:
in response to the flow item change request, determining a first experimental flow that is added or modified;
when a start operation node and an end operation node of the first experimental flow are not within the same operation time control interval, determining whether a safe operation time is set for the first experimental flow; and
in response that no safe operation time is set for the first experimental flow, outputting the first reminder message, the first reminder message being used to remind the user to set a safe operation time for the first experimental flow.

18. The non-transitory computer-readable storage medium of claim 17, wherein the request for changing the operation time control interval further comprises:
deleting the experimental flow;
the method further comprises:
after deleting the experimental flow, determining whether a safe operation time is set for the deleted experimental flow; and
in response that the safe operation time is set for the deleted experimental flow, outputting a third reminder message, the third reminder message being used to remind the user to delete the safe operation time corresponding to the deleted experimental flow.

19. The non-transitory computer-readable storage medium of claim 15, wherein the request for changing the operation time control interval comprises: adding or modifying the operation time control interval.

20. The non-transitory computer-readable storage medium of claim 19, wherein that outputting the first reminder message in response to the flow item change request comprises:
in response to the flow item change request, determining a first operation time control interval that is added or modified;
determining whether a first experimental flow exists to replace a first sub-flow in the main flow, wherein the first experimental flow and the first sub-flow both start from a third operation node and end at a fourth operation node, the third operation node and the fourth operation node are taken from the operation nodes of the main flow, and the first experimental flow or the first sub-flow has an intersection with the first operation time control interval; and
outputting the first reminder message in response that the first experimental flow exists, the first reminder message being used to remind the user to set a safe operation time for the first experimental flow.
